(19) United States
(12) Patent Application Publication
(10) Pub. No.: US 2009/0216854 A1
(43) Pub. Date: Aug. 27, 2009

(54) CONTROLLED DEVICE, CONTROL SYSTEM, AND MANAGEMENT DEVICE

(75) Inventor: Shuji OGASAWARA, Hirakata City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi City (JP)

(21) Appl. No.: 12/388,621

(22) Filed: Feb. 19, 2009

(30) Foreign Application Priority Data
Feb. 21, 2008 (JP) JP2008-040323

(51) Int. Cl. G06F 15/173

(52) U.S. Cl. 709/208

(57) ABSTRACT

An aspect of the invention provides a controlled device that comprises: a directory storing unit comprising: a process entry that indicates a process to be remotely controlled by a control device via a network; and a directory that manages a content associated with the process entry, which represents a response message to a remote control instruction on the process entry; a directory transmitter configured to transmit information on the directory stored in the directory storing unit to the control device via the network; an access request receiver configured to receive a remote control instruction from the control device, the remote control instruction for a specific process entry in the directory and received as an access request for a content associated with the specific process entry; and a controller configured to execute a process of the process entry associated with the access request received by the access request receiver.

### CROSS REFERENCE TO RELATED APPLICATIONS

This application claims priority based on 35 USC 119 from prior Japanese Patent Application No. P2008-040323 filed on Feb. 21, 2008, entitled “Controlled Device, Control System, and Management Device”, the entire contents of which are incorporated herein by reference.

### BACKGROUND OF THE INVENTION

1. Field of the Invention

The present invention relates to a controlled device remotely controlled via a network, a control system, and a management device.

2. Description of Related Art

In recent years, AV equipment and home appliances connecting to networks have been increasingly developed. A Universal Plug and Play (UPnP)-AV used in the Digital Living Network Alliance (DLNA) is an example of a protocol used for networking AV equipment. The UPnP-AV is a specification defining commands and the like for controlling AV equipment. A content directory service (CDS) is one of services defined therein.

Japanese Patent Application Publication No. 2005-151569 discloses a media server device. The media server device is described the operation of a tuner device by using a CDS. When a media player on a client side accesses a certain URI (Uniform Resource Identifier) of the CDS, an equipment control is performed in a method, for example, that a channel is switched according to the accessed URI, and then a desired content is delivered.

Japanese Patent Application Publication No. 2007-194975 discloses a content transmission device. An original content and a digest content are represented with separate URIs of a CDS by the content transmission device. When the URI for the content of the digest playback is accessed, an equipment control is performed in a way that the content for the digest playback is generated or selected, and then the desired content is delivered.

In the equipment networks as disclosed in Japanese Patent Application Publication Nos. 2005-151569 and 2007-194975, only specific processes of a controlled device on a server side such as the switching of a channel or generation of content for digest playback are remotely controllable by a control device on a client side. When other processes are to be remotely controlled by the control device, a revision needs to be made so that not only the controlled device side but also the control device side can recognize a uniquely extended portion. For this reason, versatile equipment has not been used directly as a control device.

### SUMMARY OF THE INVENTION

An aspect of the invention provides a controlled device that comprises: a directory storing unit comprising: a process entry that indicates a process to be remotely controlled by a control device via a network; and a directory that manages a content associated with the process entry, which represents a response message to a remote control instruction on the process entry; a directory transmitter configured to transmit information on the directory stored in the directory storing unit to the control device via the network; an access request receiver configured to receive a remote control instruction from the control device, the remote control instruction for a specific process entry in the directory and received as an access request for a content associated with the specific process entry; and a controller configured to execute a process of the process entry associated with the access request received by the access request receiver.

Another aspect of the invention provides a control system with a control device and a controlled device to be remotely controlled by the control device via a network, the system comprises: the controlled device comprising: a first directory storing unit comprising: a process entry that indicates a process to be remotely controlled by the control device via the network; and a directory configured to manage a content associated with the process entry, which represents a response message to a remote control instruction on the process entry; a directory transmitter configured to transmit information on the directory stored in the first directory storing unit to the control device via the network; an access request receiver configured to receive a remote control instruction from the control device, the remote control instruction being on a specific process entry managed in the directory and being received as an access request for a content associated with the specific process entry; a first controller configured to execute a process of the process entry associated with the access request received by the access request receiver; and a content transmitter configured to transmit the content in the directory storing unit to the control device via the network based on an instruction by the first control device; and the control device comprising: a directory receiver configured to receive the information on the directory stored in the first directory storing unit via the network; a second directory storing unit configured to store the information on the directory received by the directory receiver; an acceptor configured to accept the remote control instruction on the process entry managed by the information on the directory held in the second directory storing unit; a second controller configured to generate the access request for the content associated with the target process entry on the basis of the remote control instruction accepted by the acceptor; an access request transmitter configured to transmit the access request generated by the second controller via the network; and a content receiver configured to receive the content transmitted from the controlled device via the network.

Still another aspect of the invention provides a A management device that manages a controlled device to be remotely controlled, the management device comprises: a directory storing unit configured to store: a process entry that indicates a process of the controlled device to be remotely controlled by a control device via a network; and a directory configured to manage a content associated with the process entry, which represents a response message to a remote control instruction on the process entry; a directory transmitter configured to transmit information on the directory stored in the directory storing unit to the control device via the network; an access request receiver configured to receive a remote control instruction from the control device, the remote control instruction being on a specific process entry managed in the directory and being received as an access request for a content associated with the specific process entry; a controller configured to generate a control signal for instructing the controlled device to execute a process of the process entry associated with the access request received by the access request receiver; and a control signal transmitter configured to transmit the control signal generated by the controller to the controlled device.

Note that any combinations of the above components and converted forms of the expression of the invention as a method, device, system, recording medium, computer program, and the like are also valid as aspects of the invention.

### BRIEF DESCRIPTION OF THE DRAWING

FIG. 1 is a block diagram showing a configuration of a control system according to the first embodiment.

FIG. 2 shows one example of the entire operation of the control system according to the first embodiment.

FIG. 3 shows one example of a general CDS.

FIG. 4 shows one example of a CDS of a recorder according to Specific Example 1.

FIG. 5 shows an example where one item has one resource.

FIG. 6 shows a table specifying a relation between resources of the CDS of FIG. 5 and URIs.

FIG. 7 shows an example where one item has multiple resources belonging to the same media class.

FIG. 8 shows a table specifying a relation between resources of the CDS of FIG. 7 and URIs.

FIG. 9 shows an example where one item has multiple resources belonging to different media classes.

FIG. 10 shows a table specifying a relation between resources of the CDS of FIG. 9 and URIs.

FIG. 11 shows an example where a container for designating a media class is provided.

FIG. 12 shows an example where one container includes multiple items of the same contents but of different media classes.

FIG. 13 shows a first example of a CDS for a date-and-time designation process of the recorder according to Specific Example 1.

FIG. 14 shows a second example of the CDS for the date-and-time designation process of the recorder according to Specific Example 1.

FIG. 15 shows one example of a CDS of an air conditioner according to Specific Example 2.

FIG. 16 shows one example of a CDS for turning on power of the air conditioner according to Specific Example 2.

FIG. 17 shows one example of a CDS of a security camera according to Specific Example 3.

FIG. 18 is a block diagram showing a configuration of a control system according to the second embodiment.

FIG. 19 shows one example of a CDS of a management device according to the second embodiment.

### DETAILED DESCRIPTION OF EMBODIMENTS

A controlled device, control system, and management device according to embodiments are described in more detail. However, the present invention is not limited to the following embodiments and can be appropriately changed without departing from spirit and scope of the invention.

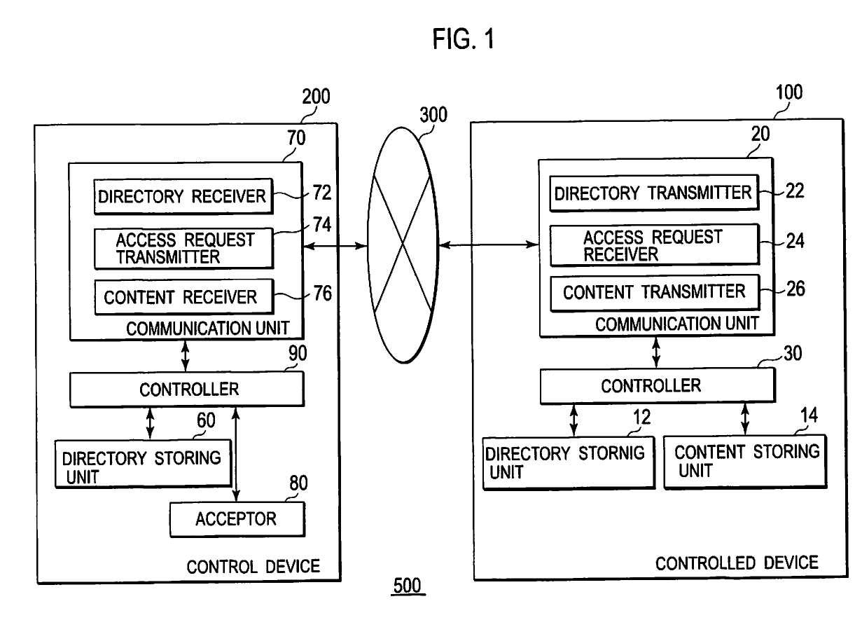

FIG. 1 is a block diagram showing a configuration of control system 500 according to the first embodiment. Control system 500 includes controlled device 100 and control device 200, which are connected to the same network 300. Control device 200 remotely controls controlled device 100 via network 300. Controlled device 100 is remotely controlled by control device 200 via network 300. Network 300 can be implemented by a wired or wireless LAN or the like.

Although single controlled device 100 and single control device 200, which are connected to the same network 300 are shown in FIG. 1 to simplify the illustration, any one or both of these devices may be connected in multiple. It is likely that multiple controlled devices 100 are connected. The terms controlled device 100 and control device 200 are named from their functions, and it is possible that specific equipment functions as controlled device 100 on the one hand and functions as control device 200 on the other hand.

Controlled device 100 includes directory storing unit 12, content storing unit 14, communication unit 20, and controller 30. Communication unit 20 includes directory transmitter 22, access request receiver 24, and content transmitter 26. Control device 200 includes directory storing unit 60, communication unit 70, acceptor 80, and controller 90. Communication unit 70 includes directory receiver 72, access request transmitter 74, and content receiver 76.

These configurations can be implemented, as hardware, in a CPU, memory, and other LSIs of a computer. Also these configurations can be implemented, as software, in a program or the like loaded into a memory. Herein, each block shown in FIG. 1 can be implemented by collaboration of hardware and software. Thus, it is understood to those skilled in the art that the blocks in various forms can be configured by only hardware, only software, or a combination thereof.

Directory storing unit 12 is configured to store a process entry for showing a process to be remotely controlled by control device 200 via network 300, and a directory for managing a content, which is associated with the process entry and which represents a response message to a remote control instruction on the process entry. All the processes performed by controlled device 100 may fall under the process to be remotely controlled. The process to be remotely controlled corresponds to one of these processes, which a designer permits control device 200 to remote control the controlled device 100. The response message is for conveying, to control device 200, a report that the process to be remotely controlled has been executed and useful information for a user such as a setting value changed by the execution. The content may be any one of a still image, a moving image, and audio. Alternatively, the content may be any combination of these.

Directory storing unit 12 is configured to hierarchically represent the multiple process entries of controlled device 100 according to the meanings thereof. In other words, directory storing unit 12 is configured to hierarchically manage the multiple process entries of controlled device 100 on the basis of the functions of the processes. Directory storing unit 12 is configured to store a directory in which content is associated with the corresponding process entry of a specific process to be remotely controlled. The directory can be formed in conformity with a CDS.

Directory storing unit 12 may store a directory in which multiple contents of different representation media are associated with one process entry. For example, still-image content and an audio content which represent messages of the same meaning may be associated with one process entry. Alternatively, plurality of contents of the same representation medium but different specifications may be associated with one process entry. For example, plural still images of the same content but having different resolutions or coded by different coding standards may be associated with one process entry.

When a directory is formed in conformity with the CDS, directory storing unit 12 can store the directory in which plural contents associated with one process entry are represented as separate items. Alternatively, directory storing unit 12 can store the directory in which plural contents associated with one process entry are represented as separate resources.

Content storing unit 14 is configured to store, as a file, the content managed by the directory held in directory storing unit 12. Directory transmitter 22 is configured to transmit information on the directory held in directory storing unit 12 to control device 200 via network 300. The transmitted information on the directory may be entire information or partial information held in directory storing unit 12. The timing for transmitting the information on the directory may be at a time of initial connection of controlled device 100 or control device 200 to network 300, or may be at a different time from the above and when directory transmitter 22 receives a request from control device 200.

Access request receiver 24 is configured to receive a remote control instruction from control device 200 on a specific process entry managed by the directory as an access request for the content associated with the process entry. More specifically, access request receiver 24 is configured to receive an access request with an identifier which uniquely specifies the content. A uniform resource identifier (URI) can be employed as the identifier.

Controller 30 is configured to execute a process of the process entry associated with the access request received by access request receiver 24. When the response message includes a setting value or the like changed by the execution of the process, controller 30 is configured to incorporate the setting value or the like in the content. Alternatively, a content which coincides with the setting value or the like is selected from plural grouped contents including the content into which the setting value or the like is incorporated.

Controller 30 is configured to execute the process and also instruct content transmitter 26 to transmit the content to control device 200. Content transmitter 26 is configured to transmit the content to control device 200 via network 300 in accordance with the instruction from controller 30.

Directory receiver 72 is configured to receive the information on the directory held in directory storing unit 12 via network 300. Directory storing unit 60 is configured to store the information on the directory received by directory receiver 72.

Acceptor 80 is configured to accept the remote control instruction on the process entry managed by the information on the directory held in directory storing unit 60. Acceptor 80 is a user interface including a display and an operation unit (not shown). The display is configured to display the directory held in directory storing unit 60. The remote control instruction which is attributable to a user operation with the operation unit and which is on any one of the process entries in the directory is accepted.

Controller 90 is configured to generate the access request for the content associated with the target process entry on the basis of the remote control instruction accepted by acceptor 80. Access request transmitter 74 is configured to transmit the access request generated by controller 90 to controlled device 100 via network 300. Content receiver 76 is configured to receive the content transmitted from controlled device 100 via network 300.

Hereinafter, an example where the above-described process to be remotely controlled is shown and the process entry is represented is described using a CDS of an UPnP-AV used in the DLNA. Controlled device 100 operates as a digital media server (DMS) of the DLNA or a media server of the UPnP-AV, and transmits the content related to the above using the CDS. Control device 200 operates as a digital media player (DMP), and remotely controls the process of controlled device 100.

For the content here, employed can be a mandatory media format specified by the DLNA such as JPEG for a still image, MPEG2-PS for a moving image, and LPCM for music.

In controlled device 100, an acquirable and controllable process is represented to be easily understood by the user operating control device 200 using a hierarchical structure of the CDS. Controlled device 100 stores an association of the URI of the content and the process to be executed therein. Controlled device 100 executes the target process when control device 200 accesses the specific URI. Accordingly, control device 200 can remotely control the process of controlled device 100.

The contents transmitted to control device 200 do not need to be different from each other for each URI. For example, one still image describing a versatile message such as “process is complete” may be prepared and shared by the plural URIs. In this case, controlled device 100 does not need to allocate a large storage capacity for the content to be transmitted as in the case of a normal DMS. Meanwhile, the content for reporting a result of executing the process to be remotely controlled may be transmitted according to the execution result. The content may be created statically or may be created dynamically.

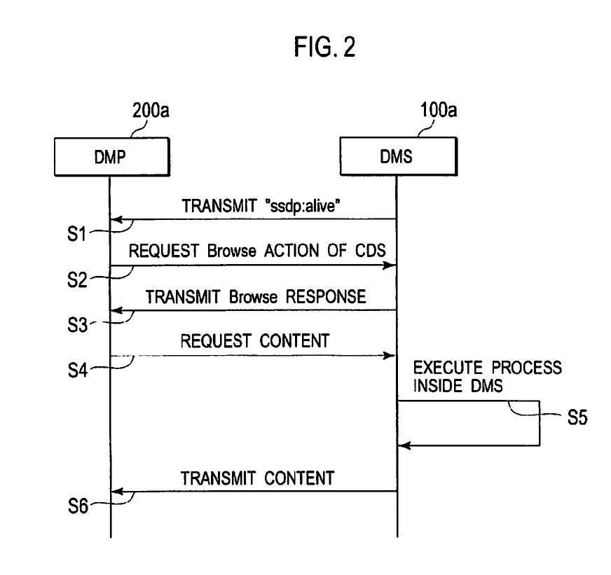

FIG. 2 shows one example of the entire operation of control system 500 according to the first embodiment. When DMS 100a is connected to network 300, DMS 100a transmits an “ssdp:alive” message to DMP 200a using a NOTIFY method of a simple service discovery protocol (SSDP) (S1).

In order to acquire information regarding a content stored in DMS 100a, DMP 200a invokes a “Browse” action of the CDS by an instruction of the user operating DMP 200a (S2). DMS 100a returns information managed by the CDS by a response to the “Browse” action (S3). According to the hierarchical structure of the CDS, the “Browse” action is repeated several times. So far, the operation is similar to those of normal DMP and DMS.

Next, by an instruction of the user operating DMP 200a, DMP 200a transmits a content acquisition request to DMS 100a (S4). DMS 100a specifies the process to be remotely controlled according to the URI included in the content acquisition request, and executes the process internally (S5). DMS 100a transmits the content requested to be acquired to DMP 200a (S6). In this respect, the transmitted content may show a state of controlled device 100 (such as the setting value changed by the above process), may show that the process is completed, or may show both. The former is transmitted after the process is executed internally (S5), but the latter can be transmitted before or simultaneously with the internal execution of the process (S5).

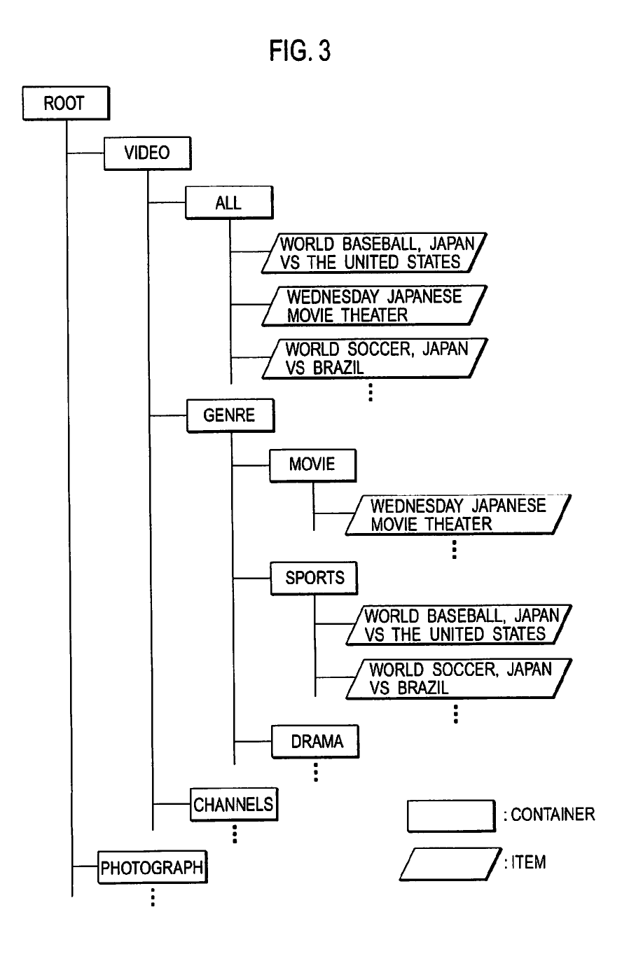

FIG. 3 shows one example of a general CDS. In the drawing, a container is shown as a rectangular block, and an item is shown as a parallelogram block. Letters on each container and each item show a name of an object represented by a title of an object property of the CDS. The item can have multiple resources. The resource shows a MIME-type or the like by “protocolInfo” and describes the URI. Refer to “UPnP ContentDirectory:1, ContentDirectory:1 Service Template Version 1.01, UPnP Forum, Jun. 25, 2002.” for details of the CDS.

In FIG. 3, a root includes containers “video,” “photograph,” and the like. The container “video” includes containers “all,” “genre,” and “channels.” The container “all” includes items “world baseball, Japan vs the United State,” “Wednesday Japanese movie theater,” “world soccer, Japan vs. Brazil,” and the like. The container “genre” includes containers “movie,” “sports,” “drama,” and the like. The container “movie” includes items “Wednesday Japanese movie theater” and the like. The container “sports” includes items “world baseball, Japan vs. the United States,” “world soccer, Japan vs. Brazil,” and the like.

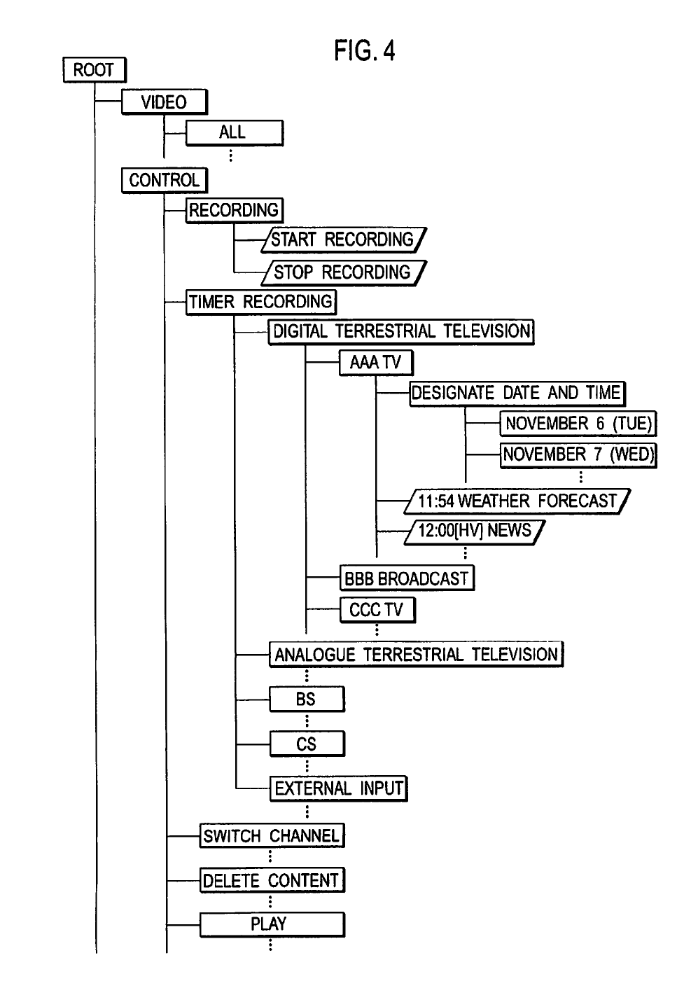

Hereinafter, a specific example of controlled device 100 is described. Specific Example 1 is an example where controlled device 100 is a recorder. FIG. 4 shows one example of CDS of the recorder according to Specific Example 1. In this example, the root includes containers “video,” “control,” and the like. The container “video” includes containers “all” and the like. The container “control” includes containers “recording,” “timer recording,” “switch channel,” “delete content,” “play,” and the like. The container “recording” includes items “start recording” and “stop recording.” The container “timer recording” includes containers “digital terrestrial television,” “analogue terrestrial television,” “BS,” “CS,” “external input,” and the like. The container “digital terrestrial television” includes containers “AMA TV,” “BBB broadcast,” “CCC TV,” and the like. The container “AAA TV” includes a container “designate date and time” and items “11:54 weather forecast,” “12:00 [HV] news,” and the like. The container “designate date and time” includes containers “November 6 (Tue),” “November 7 (Wed),” and the like.

Although not shown in detail in FIG. 4, the container “video” includes an item for a streaming playback in a similar manner to the CDS shown in FIG. 3. The container “control” includes an item for performing a process inside the recorder which is controlled device 100. In the example of FIG. 4, the item corresponds to “recording,” “timer recording,” “switch channel,” “delete content,” “play,” and the like. Note that the “play” here refers to a reproduction process inside the recorder, but not to a transmission of a content to a network. As long as a processing function is included in the recorder previously in this manner, any processing function can be represented by the CDS.

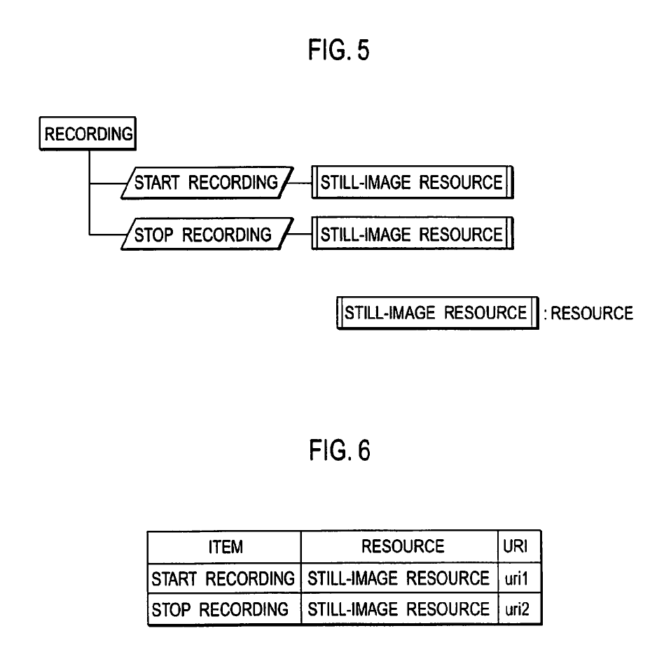

Hereinafter, a recording process of the recorder according to Specific Example 1 is described with reference to FIGS. 5 to 12. FIG. 5 shows an example where one item has one resource. In this example, control device 200 is capable of playing a still image. If control device 200 is capable of playing music or a moving image, a music resource or a moving-image resource may also be prepared.

FIG. 6 shows a table specifying a relation between resources of the CDS of FIG. 5 and URIs. This table is stored in directory storing unit 12 in the recorder. The URI is assigned as a unique identifier for each resource. Since the item and the resource have a one-to-one correspondence, the relation is such that the URI is uniquely determined when the type of the process is determined, and that the type of the process is uniquely determined when the URI is determined.

When control device 200 accesses uri 1, the recorder judges that the process to be remotely controlled is “start recording”, and starts recording a video currently being received. Here, control device 200 accessing a still-image resource means that a transmission of a still image is requested. The recorder transmits, to control device 200, a still image which notifies the user operating control device 200 that the recording is started. For example, a still image showing a message such as “Recording has started.” is transmitted.

When control device 200 accesses uri 2, the recorder judges that the process to be remotely controlled is “stop recording”, and stops the current process of recording. For example, the recorder transmits, to control device 200, a still image showing a message such as “Recording has stopped.” In the case of a music resource instead of the still image resource, a content including a voice such as “recording has started” or “recording has stopped” should be transmitted to control device 200. In the case of a moving-image resource, a moving image notifying the user that the requested process has been executed is transmitted in a similar manner.

In order to notify the user of different messages for each type of process, contents representing the number of the types of processes and messages need to be held, thereby decreasing the remaining storage capacity of controlled device 100. In contrast, for example, by preparing one versatile message such as “Designated process has been executed” which can correspond to any process, the decrease in the remaining storage capacity can be suppressed.

Instead of storing the message as the content by content storing unit 14 in advance, controller 30 may create the content dynamically according to a process requested. In this dynamic creation, information on the recorder obtained by executing the process or information on the current recorder which is useful for the user may be added. For example, when the recording is started or stopped, a message including information on free space of the recorder such as “Recording has started. Remaining capacity: 178 GB” or “Recording has stopped. Remaining capacity: 154 GB” can be transmitted.

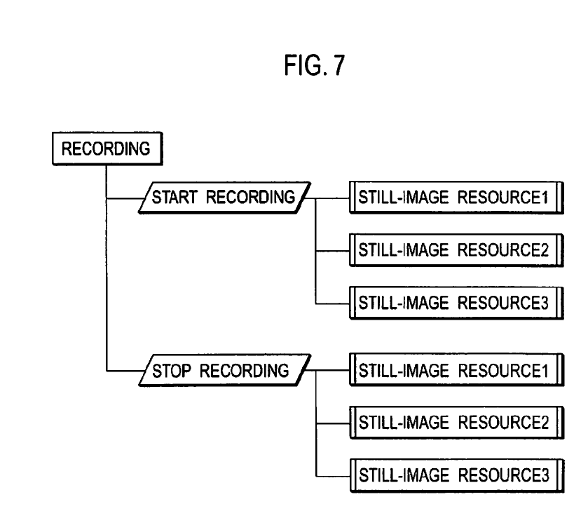

FIG. 7 shows an example where one item has multiple resources belonging to the same media class. This example refers to, for example, a case where all the multiple resources of one item belong to a still-image resource. The multiple resources here refer to those respectively having different sizes, those respectively having different coding systems, or the like. By preparing multiple resources belonging to the same media class for one item, a resource having a format easily handled by control device 200 can be selected.

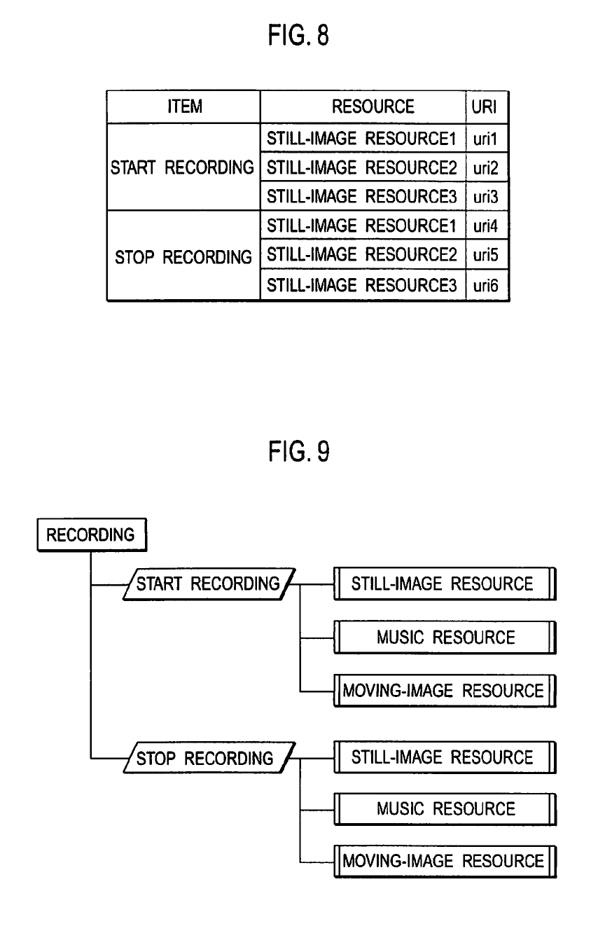

FIG. 8 shows a table specifying a relation between the resources of the CDS of FIG. 7 and URIs. This table is stored in directory storing unit 12 in the recorder. The URI is assigned as a unique identifier for each resource. Since multiple URIs are associated with one item, the relation is such that the URI is not uniquely determined even if the type of process is determined whereas the type of process is uniquely determined when the URI is determined. For example, when control device 200 accesses any URI of uris 1 to 3, the recorder starts recording. The content transmitted to control device 200 differs according to the format of the content represented by each resource.

FIG. 9 shows an example where one item has multiple resources belonging to different media classes. In this example, the multiple resources of one item belong to different media classes such as a still-image resource, a music resource, and a moving-image resource. Since an item normally shows information on a media class in a class property, the configuration in which resources of different media classes exist in an item possibly decreases versatility.

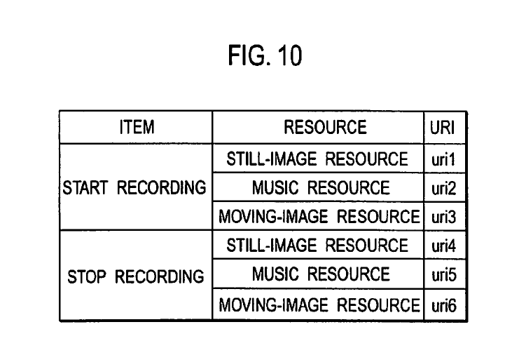

FIG. 10 shows a table specifying a relation between the resources of the CDS of FIG. 9 and URIs. Other than that multiple resources of different media classes exist, it is similar to the example of FIG. 8.

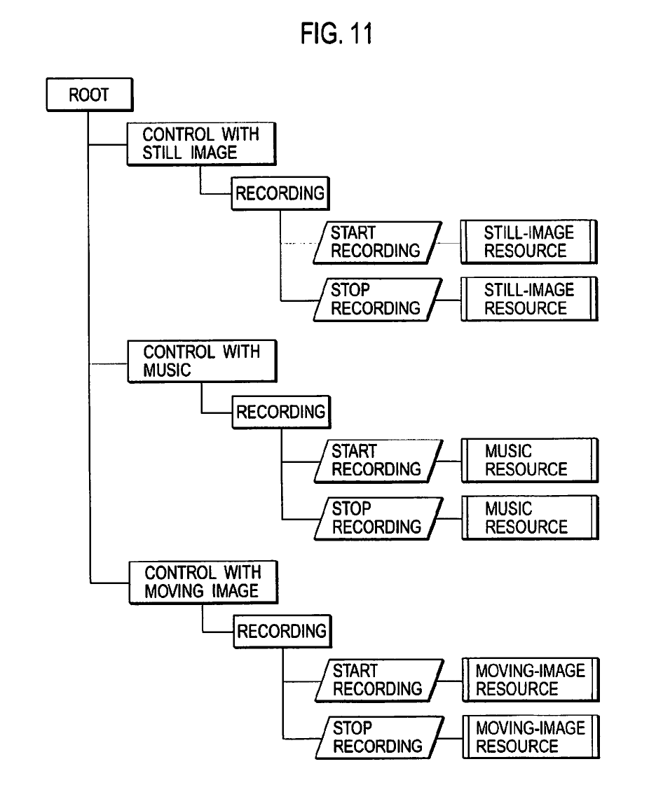

FIG. 11 shows an example where a container for designating a media class is provided. A root includes such containers as “control with still image,” “control with music,” and “control with moving image.” The containers are associated with similar items. The configuration in the example of FIG. 11 provides higher versatility than that in the example of FIG. 9. A remote control is made possible by control device 200 supporting any media class. Control device 200 first lets the user select the media class, which is used to perform the remote control, and then select a desired process.

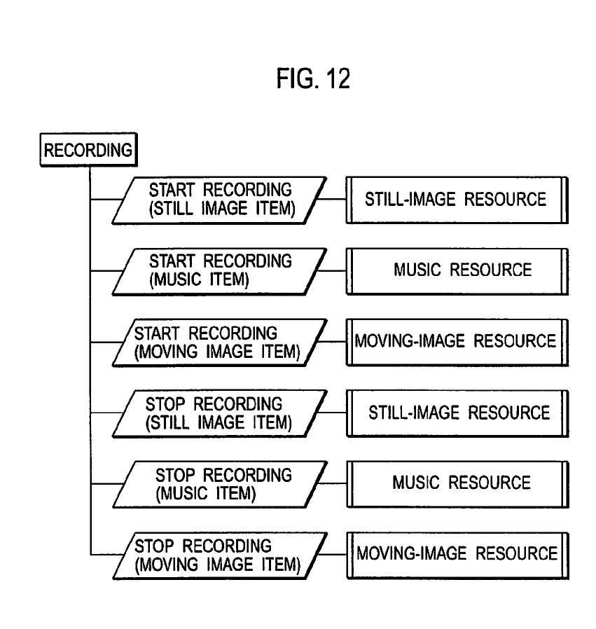

FIG. 12 shows an example where one container includes multiple items of the same contents but of different media classes. In the example of FIG. 12, the user does not select the media class for performing remote control at first as in the example of FIG. 11. Control device 200 lets the user select one of the multiple items included in the container “recording” to determine the media class, which is used to perform the remote control.

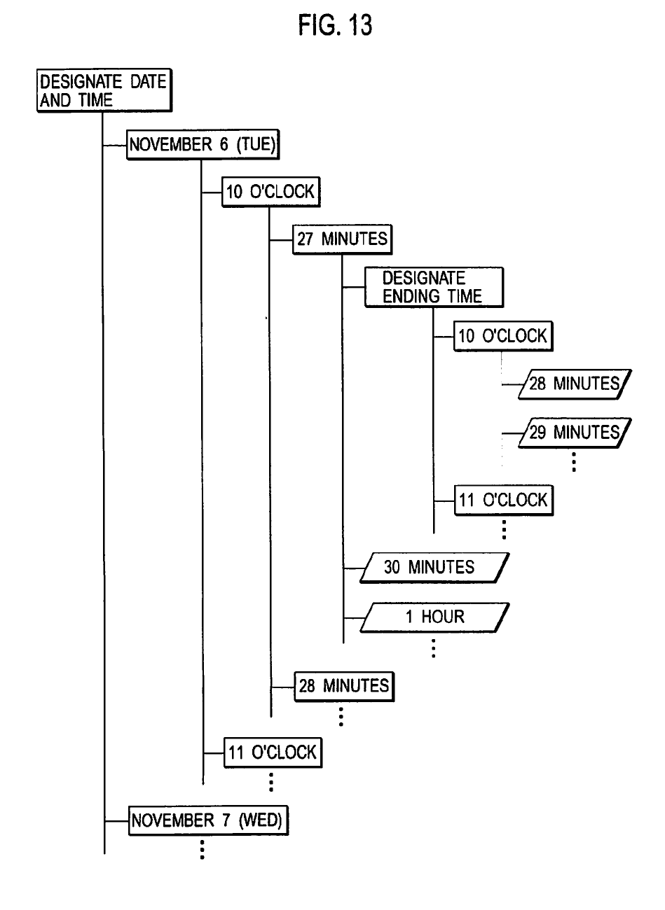

Hereinafter, a date-and-time designation process according to Specific Example 1 is described as an example. FIG. 13 shows a first example of a CDS for the date-and-time designation process of the recorder according to Specific Example 1. In this example, the container “designate date and time” includes containers “November 6 (Tue),” “November 7 (Wed),” and the like. The container “November 6 (Tue)” includes containers “10 o'clock,” “11 o'clock,” and the like. The container “10 o'clock” includes containers “27 minutes,” “28 minutes,” and the like. The container “27 minutes” includes a container “designate ending time” and items “30 minutes,” “1 hour,” and the like. The container “designate ending time” includes containers “10 o'clock,” “11 o'clock,” and the like. The container “10 o'clock” includes items “28 minutes,” “29 minutes,” and the like.

In the CDS of FIG. 13, the containers are selected in an order of “date,” “hour,” and “minute” of a timer starting date and time. When an ending time is precisely set, the container and items are selected in an order of “designate ending time,” “hour,” and “minute.” When the ending time is not precisely set, an item such as “30 minutes” or “1 hour” is selected as a timer continuance time after a timer starting time has been selected. Accordingly, a date-and-time designation of a timer recording can be remotely controlled.

In the date-and-time designation, the content of the CDS needs to be changed dynamically according to the current date and time. This applies also to a case where a list of current and future programs is presented and a program name within the list is selected for the timer recording. Note that, a similar concept to the case of the recording process applies to the relations among the item, resource, and URI, and therefore description thereof are omitted.

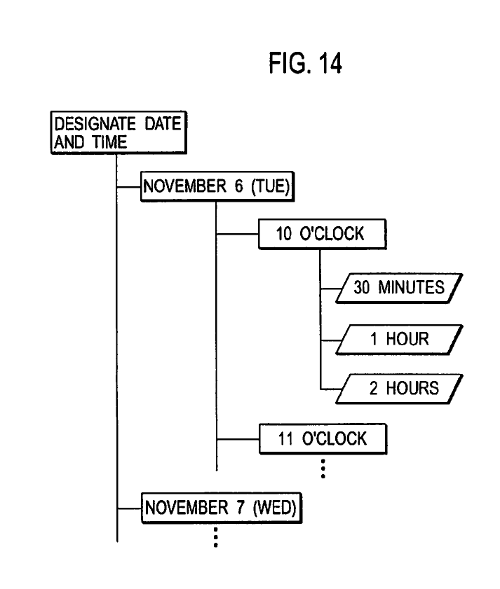

FIG. 14 shows a second example of the CDS for the date-and-time designation process of the recorder according to Specific Example 1. In this example, the container “designate date and time” includes containers “November 6 (Tue),” “November 7 (Wed),” and the like. The container “November 6 (Tue)” includes containers “10 o'clock,” “11 o'clock,” and the like. The container “10 o'clock” includes containers “30 minutes,” “1 hour,” and “2 hours.”

The example of FIG. 14 is more simplified than the example of FIG. 13. From limited candidates, the containers are selected in an order of “date,” “hour,” and “minute” of the timer starting date and time, and then the item such as “30 minutes,” “1 hour,” and “2 hours” is selected as the timer continuance time.

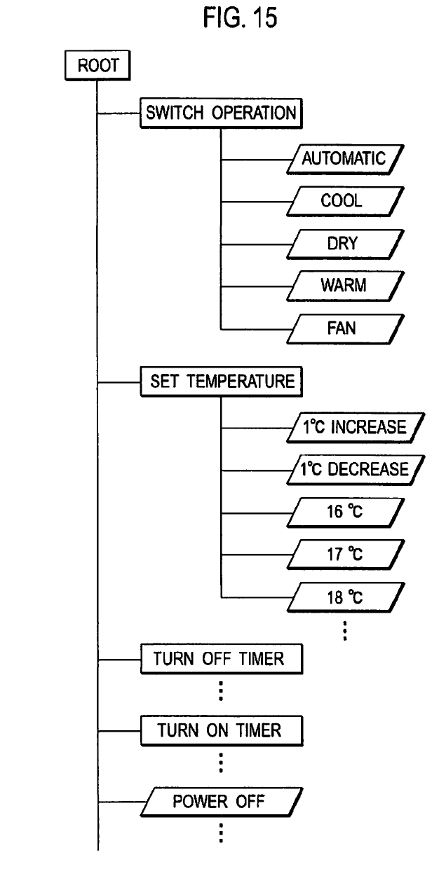

Next, Specific Example 2 is described. Specific Example 2 is an example where controlled device 100 is an air conditioner. FIG. 15 shows one example of a CDS of the air conditioner according to Specific Example 2. In this example, a root includes containers “switch operation,” “set temperature,” “turn off timer,” “turn on timer,” and the like and an item “turn off power.” The container “switch operation” includes items “automatic,” “cool,” “dry,” “warm,” and “fan.” The container “set temperature” includes items “increase 1° C.,” “decrease 1° C.,” “16° C.,” “17° C.,” “18° C.,” and the like.

As long as a processing function is included in the air conditioner in advance in this manner, any processing function can be represented by the CDS. A similar concept to the case of the recorder applies to the relations among the item, resource, and URI, and therefore description thereof are omitted.

In the case of an air conditioner, the specification of a processor or a memory is generally poorer than that of a recorder. In the CDS representing a process entry showing a process of the air conditioner, only a still image is thus preferably supported. For example, only one still image of a small size showing a versatile message such as “Setting is complete.” is preferably prepared. Accordingly, only this still image needs to be transmitted for any process remotely controlled, and the load on the air conditioner can be minimized. Note that, when there is enough process capability of the air conditioner, the air conditioner as controlled device 100 may dynamically generate a content to be transmitted and transmit the content to control device 200. For example, a still image showing a message such as “Temperature has been set at 18° C.” may be transmitted.

Note that, while a process entry for turning on or off power or the like can be represented by the CDS, the power needs to be turned off after the content is transmitted to control device 200. This is because, in the case of “turn off power,” the air conditioner is stopped after the power is turned off.

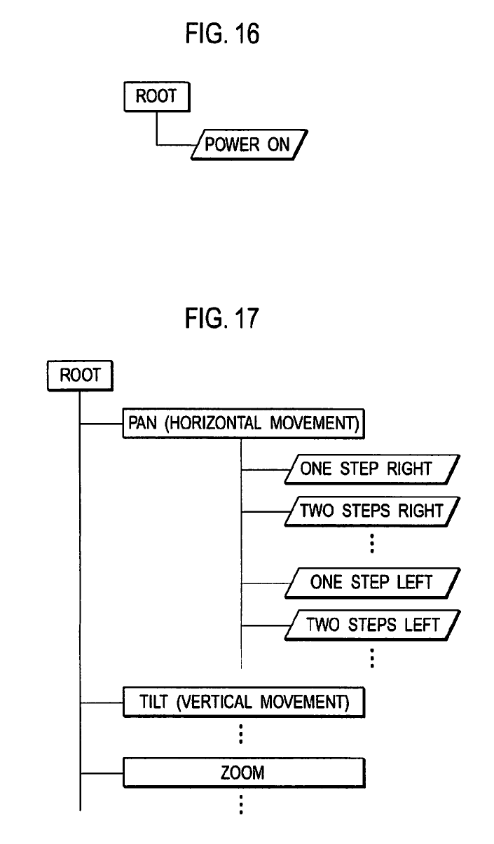

FIG. 16 shows one example of the CDS for turning on the power of the air conditioner according to Specific Example 2. To support turning on the power, the CDS needs to be valid even when the power is turned off. In this case, a minimum CDS as shown in FIG. 16 suffices.

Next, Specific Example 3 is described. Specific Example 3 is an example where controlled device 100 is a security camera. FIG. 17 shows one example of a CDS of the security camera according to Specific Example 3. In this example, a root includes containers “pan (horizontal movement),” “tilt (vertical movement),” “zoom,” and the like. The container “pan (horizontal movement)” includes items “one step right,” “two steps right,” “one step left,” “two steps left,” and the like.

As long as a processing function is included in the security camera in advance in this manner, any processing function can be represented by the CDS. A similar concept to the case of the recorder applies to the relations among the item, resource, and URI, and therefore description thereof are omitted.

In the case of the security camera, not only can a content notifying that a process has been executed be transmitted but also an image after the camera has actually been moved can be transmitted as content. With a moving-image resource, a process can be continued until an instructed operation is stopped, and then images during the continuation can be transmitted as a moving-image content.

In The first embodiment as described above, versatile DMP 200a can remotely control DMS 100a via the network merely by dealing with the DMS 100a side. As long as processing functions are included in DMS 100a, all of them can be represented by the CDS. Since DMP 200a only needs to perform minimal required operations, DMPs of older generations can be used. A difference in manufacturers of DMS 100a and DMP 200a does not cause limitations.

A simple extension suffices on the DMS 100a side. For example, by sharing a small-sized content of a versatile message in various scenes, the load on the DMS 100a side can be minimized.

It is possible to control not only AV equipment within a frame of the UPnP-AV which is an original specification intended for AV but also domestic appliances. Normally, in order to define and control domestic appliances as devices with the UPnP, a unique device definition and definition for action become necessary, and equipment to instruct control also becomes a unique control point. In contrast, in the first embodiment, control can be performed using AV equipment such as a TV, PC, or mobile phone which operates as DMP 200a.

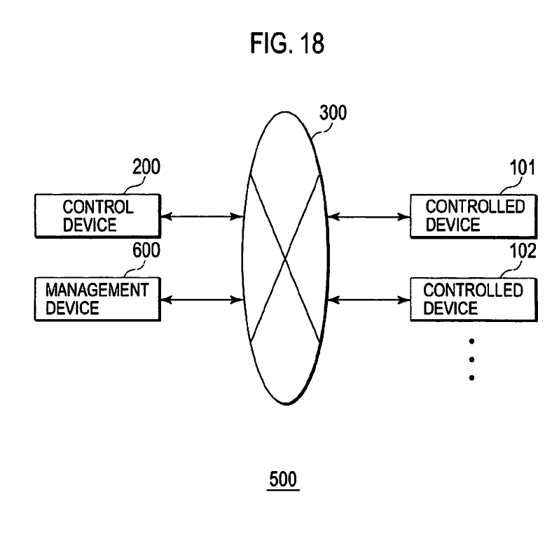

FIG. 18 is a block diagram showing a configuration of control system 500 according to the second embodiment. Control system 500 includes management device 600, control device 200, and controlled devices 101, 102, and the like which are connected to the same network 300. Note that controlled devices 101, 102, and the like may communicate with management device 600 by a communication method, e.g., infrared communication, other than through network 300.

Management device 600 manages processes of controlled devices 101, 102, and the like, which are remotely controlled. Management device 600 may be equipment such as a PC or mobile phone, or may be remote control equipment. When directories and contents of controlled devices 101, 102, and the like can be acquired from a device, e.g., a server of a manufacturer thereof, other than controlled devices 101, 102, and the like, management device 600 may be equipment incapable of two-way communications with controlled devices 101, 102, and the like. Of course, when the two-way communications with controlled devices 101, 102, and the like are possible, management device 600 may directly acquire the directories and contents from controlled devices 101, 102, and the like.

The configuration and operation of management device 600 are basically similar to the configuration and operation of controlled device 100 according to the first embodiment. Hereinafter, the differences are described. Controller 30 is configured to generate a control signal for instructing an appropriate controlled device to execute a process in a process entry corresponding to a content of a destination of an access request received by access request receiver 24. Simultaneously, controller 30 is configured to instruct content transmitter 26 to transmit the content to control device 200.

A control signal transmitter (not shown) is configured to transmit the control signal generated by controller 30 to controlled devices 101, 102, and the like. The control signal may be transmitted by infrared communication, may be transmitted via network 300, or may be transmitted by other means of communication.

Control device 200 instructs management device 600 via network 300 to remotely control controlled devices 101, 102, and the like. Unlike controlled device 100 according to the first embodiment, controlled devices 101, 102, and the like do not need to have components for transmitting directories and contents to control device 200. When directories and contents of controlled devices 101, 102, and the like are registered in advance in management device 600, controlled devices 101, 102, and the like also do not need to have components for transmitting directories and contents to management device 600.

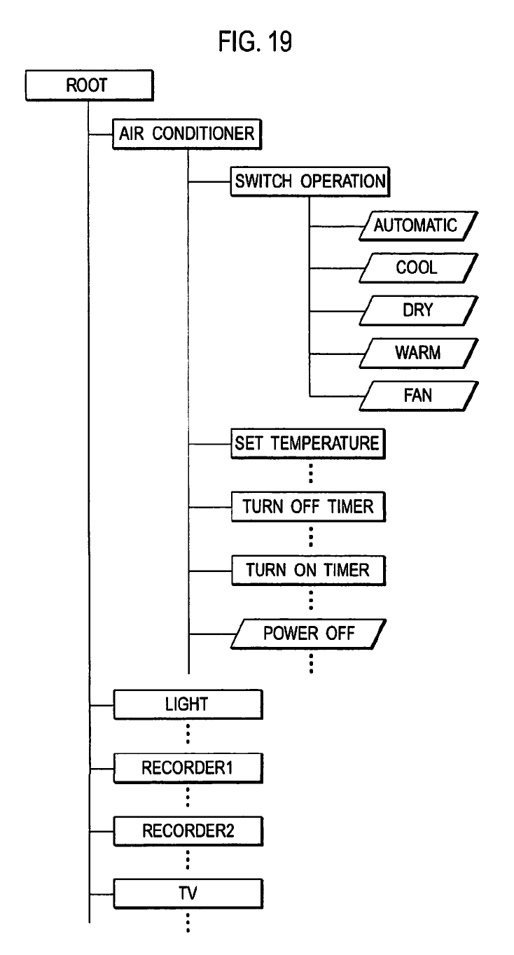

FIG. 19 shows one example of a CDS of management device 600 according to the second embodiment. Shown is an example where management device 600 is a remote control device. The remote control device can control an air conditioner, a light, two recorders, and a TV. The remote control device may control each equipment with infrared radiation as in general remote control devices, or may be equipment having another remote controller.

In FIG. 19, each equipment controllable by the remote control device is shown as a container. Process entries of processes which can be controlled using a hierarchical structure of the CDS are represented in the containers for each equipment. Specifically, a root includes containers “air conditioner,” “light,” “recorder 1,” “recorder 2,” “TV,” and the like. The container “air conditioner” includes containers “switch operation,” “set temperature,” “turn off timer,” “turn on timer,” and the like and an item “turn off power,” and the like. The container “switch operation” includes items “automatic,” “cool,” “dry,” “warm,” “fan,” and the like. Similar concepts to the case of the first embodiment apply to the relations among the item, resource, and URI as well as the content to be transmitted to control device 200, and therefore descriptions thereof are omitted.

Instead of representing multiple equipments by single CDS as in FIG. 19, each equipment may be represented by separate CDS respectively. For example, multiple UPnP devices which operate as a media server of the UPnP or a DMS of the DLNA are managed by CDSs of the respective UPnP devices in one remote control device. In this case, since the UPnP devices are managed by one remote control device, all IP addresses thereof become the same. However, TCP ports to be accessed differ from each other, and the respective devices can be identified by uuids.

According to The second embodiment as described above, a similar effect to that of the first embodiment is obtained. Even when there is no direct communication unit between control device 200 and controlled devices 101, 102, and the like, control device 200 can remotely control controlled devices 101, 102, and the like by using management device 600.

Several embodiments have been described so far. It is understood to those skilled in the art that these embodiments are exemplary, that various modified examples can be made regarding combinations of those components and processes, and that such modified examples are also included in the scope of the invention.

In the embodiments above, examples where a unique item or a unique resource is not used has been described. In a modified example below, an example where a unique item or a unique resource is used is described. Depending on DMP 200a, there is a case where DMP 200a itself accesses all of the contents or an unspecified content independently of selection by the user. This refers to, for example: a process of DMP 200a checking what is included in a content to judge whether or not the content is reproducible; a slideshow in which contents are consecutively displayed; and the like. As a measure for cases where such DMP 200a exists, a unique item is provided as a control item on the CDS, or a unique resource is provided as a control resource. For example, identification is performed according to a class property of the item or according to a MIME-type of protocol information (“protocolInfo”) on the resource. In this modified example, although DMP 200a also has to be adjusted so that the unique item or unique resource can be identified, the reliability and security of control system 500 can be improved.

A disclosure matter for which disclosure is to be requested and the process to be remotely controlled may be managed collectively by one CDS.

As described above, with the controlled device, the control system, and the management device of the embodiments, various remote control can be received from an ordinary equipment via a network without the extension of the equipment.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A controlled device comprising:
a directory storing unit comprising:
a process entry that indicates a process to be remotely controlled by a control device via a network; and
a directory that manages a content associated with the process entry, which represents a response message to a remote control instruction on the process entry;
a directory transmitter configured to transmit information on the directory stored in the directory storing unit to the control device via the network;
an access request receiver configured to receive a remote control instruction from the control device, the remote control instruction for a specific process entry in the directory and received as an access request for a content associated with the specific process entry; and
a controller configured to execute a process of the process entry associated with the access request received by the access request receiver.

2. The controlled device of claim 1, further comprising a content transmitter configured to transmit the content in the directory storing unit to the control device via the network based on an instruction by the control device, wherein
the controller executes the process and instructs the content transmitter to transmit the content to the control device.

3. The controlled device of claim 1, wherein the directory storing unit hierarchically manages a plurality of the process entries of the controlled device on the basis of functions of processes of the process entries.

4. The controlled device of claim 1, wherein the directory storing unit stores the directory in which a plurality of the process entries of the controlled device are hierarchically represented according to meanings of the process entries, and in which contents are associated with the corresponding process entries of specific processes to be remotely controlled.

5. The controlled device of claim 1, wherein the directory storing unit stores the directory, in which a plurality of contents of different representation media are associated with one process entry.

6. The controlled device of claim 1, wherein
the directory conforms with a content directory service (CDS); and
the directory storing unit stores the directory in which a plurality of contents associated with one process entry are represented as separate items, respectively.

7. The controlled device of claim 1, wherein
the directory conforms with a content directory service (CDS); and
the directory storing unit stores the directory in which a plurality of contents associated with one process entry are represented as separate resources, respectively.

8. The controlled device of claim 1, wherein the access request receiver receives the access request with an identifier which uniquely specifies the content.

9. A control system with a control device and a controlled device to be remotely controlled by the control device via a network, the system comprising:
the controlled device comprising:
a first directory storing unit comprising:
a process entry that indicates a process to be remotely controlled by the control device via the network; and
a directory configured to manage a content associated with the process entry, which represents a response message to a remote control instruction on the process entry;
a directory transmitter configured to transmit information on the directory stored in the first directory storing unit to the control device via the network;
an access request receiver configured to receive a remote control instruction from the control device, the remote control instruction being on a specific process entry managed in the directory and being received as an access request for a content associated with the specific process entry;
a first controller configured to execute a process of the process entry associated with the access request received by the access request receiver; and
a content transmitter configured to transmit the content in the directory storing unit to the control device via the network based on an instruction by the first control device; and
the control device comprising:
a directory receiver configured to receive the information on the directory stored in the first directory storing unit via the network;
a second directory storing unit configured to store the information on the directory received by the directory receiver;
an acceptor configured to accept the remote control instruction on the process entry managed by the information on the directory held in the second directory storing unit;
a second controller configured to generate the access request for the content associated with the target process entry on the basis of the remote control instruction accepted by the acceptor;
an access request transmitter configured to transmit the access request generated by the second controller via the network; and
a content receiver configured to receive the content transmitted from the controlled device via the network.

10. The controlled device of claim 9, wherein the first directory storing unit hierarchically manages a plurality of the process entries of the controlled device on the basis of functions of processes of the process entries.

11. The controlled device of claim 9, wherein the first directory storing unit stores the directory in which a plurality of the process entries of the controlled device are hierarchically represented according to meanings of the process entries, and in which contents are associated with the corresponding process entries of specific processes to be remotely controlled.

12. The controlled device of claim 9, wherein the first directory storing unit stores a directory, in which a plurality of contents of different representation media are associated with one process entry.

13. The controlled device of claim 9, wherein
the directory conforms with a content directory service (CDS); and
the first directory storing unit stores the directory, in which a plurality of contents associated with one process entry are represented as separate items, respectively.

14. The controlled device of claim 9, wherein
the directory conforms with a CDS; and
the first directory storing unit stores the directory in which a plurality of contents associated with one process entry are represented as separate resources, respectively.

15. The controlled device of claim 9, wherein the access request receiver receives the access request with an identifier which uniquely specifies the content.

16. A management device that manages a controlled device to be remotely controlled, the management device comprising:
a directory storing unit configured to store:
a process entry that indicates a process of the controlled device to be remotely controlled by a control device via a network; and
a directory configured to manage a content associated with the process entry, which represents a response message to a remote control instruction on the process entry;
a directory transmitter configured to transmit information on the directory stored in the directory storing unit to the control device via the network;
an access request receiver configured to receive a remote control instruction from the control device, the remote control instruction being on a specific process entry managed in the directory and being received as an access request for a content associated with the specific process entry;
a controller configured to generate a control signal for instructing the controlled device to execute a process of the process entry associated with the access request received by the access request receiver; and
a control signal transmitter configured to transmit the control signal generated by the controller to the controlled device.

17. The management device of claim 16, further comprising a content transmitter configured to transmit the content to the control device via the network according to an instruction by the controller, wherein
the controller generates the control signal and instructs the content transmitter to transmit the content to the control device.
